(19) United States
(12) Patent Application Publication
(10) Pub. No.: US 2018/0089585 A1
(43) Pub. Date: Mar. 29, 2018

(54) MACHINE LEARNING MODEL FOR PREDICTING STATE OF AN OBJECT REPRESENTING A POTENTIAL TRANSACTION

(71) Applicant: salesforce.com, inc., San Francisco, CA (US)

(72) Inventors: Scott Thurston Rickard, Jr., Bellevue, WA (US); Elizabeth Rachel Balsam, San Francisco, CA (US); Tracy Morgan Backes, Seattle, WA (US); Siddharth Rajaram, Seattle, WA (US); Zachary Alexander, Snoqualmie, WA (US); Gregory Thomas Pascale, Seattle, WA (US)

(21) Appl. No.: 15/280,126

(22) Filed: Sep. 29, 2016

(51) Int. Cl. G06N 99/00

(52) U.S. Cl. CPC G06N 99/005

(57) ABSTRACT

An online system stores objects representing potential transactions of an enterprise. The online system uses machine learning techniques to predict likelihood of success for a potential transaction object. The online system stores historical data describing activities associated with potential transaction objects and uses the stored data as training dataset for a predictor model. The online system extracts features describing potential transaction objects and provides these as input to the predictor model for predicting the likelihood of success of a given potential transaction. The online system may use predictions of likelihood of success of potential transactions to identify a set of potential transactions that should be acted upon to maximize the benefit the enterprise within a time interval, for example, by the end of the current month.

### BACKGROUND

### Field of Art

The disclosure relates to machine learning techniques for predicting states of objects representing potential transactions.

### Description of the Related Art

Online systems used by enterprises store large amount of data describing entities associated with the enterprise such as user accounts, documents, transactions, and so on. Examples of such online systems include multi-tenant systems that are configured to store data of multiple enterprises. These online systems provide tools for users associated with enterprises configured to allow the users to store and manage information processed by the enterprises, for example, for managing user interactions or transactions of the enterprise. Conventional tools supported by such online systems are often inadequate in terms of providing valuable analysis of the user interactions or guidance in terms of subsequent actions that users need to perform so as to maximize their impact on the enterprise.

### BRIEF DESCRIPTION OF DRAWINGS

The disclosed embodiments have advantages and features which will be apparent from the detailed description, the appended claims, and the accompanying figures (or drawings). A brief introduction of the figures is below.

FIG. 1 shows an overall system environment illustrating an online system for storing and analyzing objects associated with potential transactions, in accordance with an embodiment.

FIG. 2 shows the system architecture of an object analyzer for analyzing potential transaction objects, in accordance with an embodiment.

FIG. 3 shows the process of analyzing potential transaction objects, in accordance with an embodiment.

FIG. 4 shows an example of historical data associated with a potential transaction object stored in the online system, in accordance with an embodiment.

FIG. 5 shows the process of modifying the state of a potential transaction object, in accordance with an embodiment.

FIG. 6 shows the process of training a machine learning model for predicting success of a potential transaction, in accordance with an embodiment.

FIG. 7 shows the process of analyzing potential transaction objects, in accordance with an embodiment.

FIG. 8 illustrates how the predicted score for a potential transaction varies with time as a result of user interactions associated with the potential transaction, in accordance with an embodiment.

FIG. 9 illustrates a ranked list of potential transactions recommended by the online system, in accordance with an embodiment.

FIG. 10 illustrates an example of statistical analysis for predicting an aggregate amount expected from potential transactions at the end of a time period, in accordance with an embodiment.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

An online system stores data of one or more enterprises and provides tools that provide valuable information to users of the enterprise. These tools provide analysis of objects representing entities associated with an enterprise, for example, objects storing information associated with potential transactions of the enterprise. For example, a user associated with the enterprise may interact with a third party in anticipation that the third party would perform a transaction that benefits the enterprise. The online system uses machine learning techniques to predict likelihood of success of a potential transaction. For example, the online system uses predictions of likelihood of success of potential transactions to identify potential transactions that should be acted upon to maximize the benefit the enterprise within a time interval, for example, by the end of the current month. The online system provides recommendations of potential transactions for users of the enterprise to focus on, to maximize the value to the enterprise, for example, by increasing month end revenue numbers.

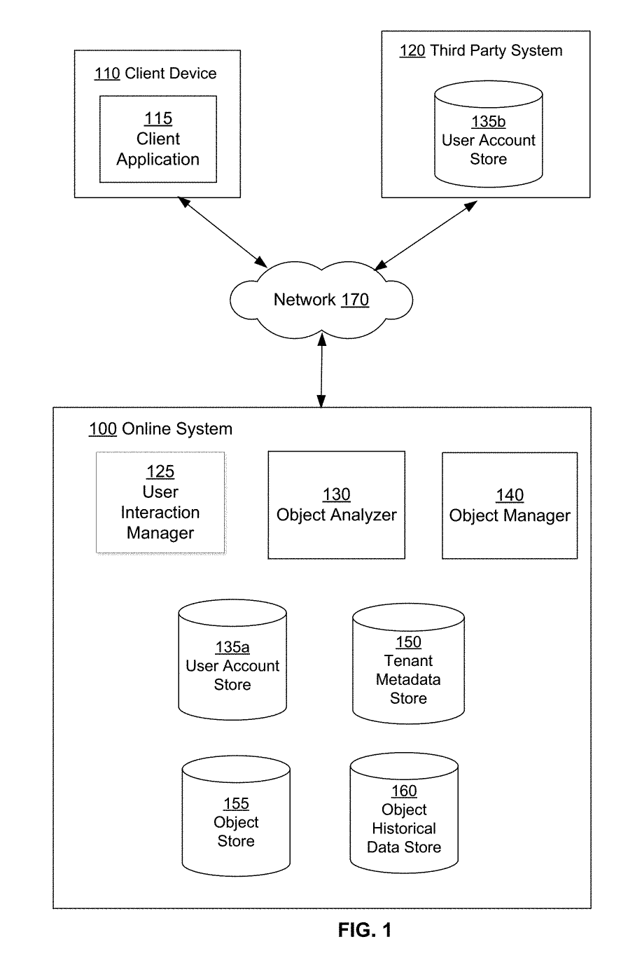

FIG. 1 shows an overall system environment illustrating an online system for storing and analyzing objects associated with potential transactions, in accordance with an embodiment. The overall system environment includes an online system 100, one or more client devices 110, a third party system 120, and a network 170. Other embodiments may use more or less or different systems than those illustrated in FIG. 1. Functions of various modules and systems described herein can be implemented by other modules and/or systems than those described herein.

FIG. 1 and the other figures use like reference numerals to identify like elements. A letter after a reference numeral, such as “135a,” indicates that the text refers specifically to the element having that particular reference numeral. A reference numeral in the text without a following letter, such as “135,” refers to any or all of the elements in the figures bearing that reference numeral (e.g. “135” in the text refers to reference numerals “135a” and/or “135b” in the figures).

A client device 110 is used by users to interact with the online system 100. A user interacts with the online system 100 using client application 115. An example of a client application 115 is a browser application. In an embodiment, the client application 115 interacts with the online system 100 using requests sent over network 170. The client device 110 presents user interfaces configured by the online system 100 via the client application 115.

A third party system 120 is associated with a third party that may be an enterprise. The third party may be a potential customer of an enterprise associated with an online system 100. The third party system 120 includes a user account store 135b that stores information describing users of the third party system 120. The third party system 120 may include other components not shown in FIG. 1.

An enterprise E1 may store information describing activities of the enterprise E1 on the online system 100. In an example scenario, a user U1 of enterprise E1 identifies an enterprise E2 (a third party) as a potential customer for a product or service offered by enterprise E1. Accordingly, the user U1 of the enterprise E1 identifies a potential transaction between enterprise E1 and enterprise E2 related to the product or service offered by enterprise E1. The potential transaction may be a sale of the product or service or an agreement that results in enterprise E2 using the product or service of enterprise E1 in exchange for certain remuneration, for example, a monetary payment. The potential transaction is also referred to herein as an opportunity.

The user U1 interacts with users of enterprise E2 to ensure that the potential transaction or the opportunity is converted to an actual transaction that is successfully executed. In this situation, the potential transaction or opportunity is considered successful or is closed as a success. Alternatively, the user U1 may determine that the likelihood of having a successful transaction with enterprise E2 is below a threshold and accordingly determine that the opportunity is closed as a failure.

The interactions between user U1 and users associated with the enterprise E2 may include online interactions with the third party system 120, for example, via email, messenger, video conference, and so on. Other interactions between user U1 and users associated with the enterprise E2 may be performed outside the third party system 120 and/or the online system 100. For example, the user U1 and users associated with the enterprise E2 may interact via phone, mail, or in person. However, information describing these interactions is provided to the online system 100 and stored by the online system 100 in connection with the potential transaction associated with enterprise E2.

The online system 100 stores information associated with one or more enterprises. The information stored in connection with an enterprise in the online system 100 includes objects representing various entities associated with the enterprise, for example, user accounts representing users, objects representing potential transactions, and so on. The information stored in connection with an enterprise in the online system 100 includes historical data representing various interactions associated with enterprises, for example, user interactions associated with a potential transaction.

The online system 100 represents potential transactions or opportunities as potential transaction objects. A potential transaction object may also be referred to herein as an opportunity object. The online system 100 uses historical data describing state changes of potential transaction objects to predict whether a new potential transaction would close as a success or a failure. Accordingly, the online system 100 predicts whether the new potential transaction would result in a transaction or fail to result in a transaction. The online system 100 may generate statistical aggregate information based on the predicted information. For example, the online system 100 may generate aggregate sales predictions for a given time period, for example, an expected revenue based on sales that are predicted to close successfully by the month end. The online system 100 compares various combinations of potential transactions that can be acted upon within a time interval and makes recommendations as to which potential transactions should be actively pursued by the associated users of the online system 100 to maximize the expected revenue.

The online system 100 includes a user interaction manager 125, an object manager 140, an object analyzer 130, a user account store 135, a tenant metadata store 150, an object store 155, and an object historical data store 160. Other embodiments may include more or fewer modules than those indicated herein. Functions indicated herein as being performed by a module may be performed by other modules than those indicated herein.

The user interaction manager 125 configures user interfaces for presenting to users via client devices 110. The user interaction manager 125 receives user interactions from client devices 110. In an embodiment, the user interaction manager 125 configures a user interface that allows users to provide information describing user interactions that are performed outside the online system 100. For example, if a first user of the online system 100 interacts with a second user of the third party system 120 via phone, the first user may provide information describing the call via a user interface to the user interaction manager 125.

The object store 155 stores objects representing entities associated with an enterprise. An enterprise may be an organization, a business, a company, a club, or a social group. An object may represent an account representing a business partner or potential business partner (e.g. a client, vendor, distributor, etc.) of a user, and may include attributes describing a company, subsidiaries, or contacts at the company. As another example, an object may represent a project that a user is working on with an existing partner, or a project that the user is trying to get. An object may represent an account representing a user or another entity associated with the enterprise. For example, an account may represent a customer of the first enterprise. An object may represent a user of the online system.

In an embodiment, the object store 155 stores an object as one or more records in a database. An object has data fields that are defined by the structure of the object (e.g. fields of certain data types and purposes). For example, an object representing an entity may store information describing the potential customer, a status of the opportunity indicating a stage of interaction with the customer, and so on.

The object store 155 may be implemented as a relational database storing one or more tables. Each table contains one or more data categories logically arranged as columns or fields. Each row or record of a table contains an instance of data for each category defined by the fields. For example, an object store 155 may include a table that describes a customer with fields for basic contact information such as name, address, phone number, fax number, etc. Another table might describe a purchase order, including fields for information such as customer, product, sale price, date, etc.

An object may include links or references to other objects. For example an opportunity object may include links to contact objects and account objects, an account object may include links to contact objects and so on. An object may have outgoing links that allow the object to refer to other objects as well as incoming links that allow other objects to refer to the object.

An object may represent a potential transaction, also referred to herein as an opportunity. For example, a user associated with a first enterprise may identify a third party, for example, another enterprise as a potential customer of a product or service offered by the first enterprise. The online system 100 creates a potential transaction object representing the engagement with the third party. In an embodiment, the user of the first enterprise provides information describing the potential transaction to the online system. The online system 100 stores the information describing the potential transaction or the opportunity as a potential transaction object.

A potential transaction object is associated with a potential transaction type depending on the type of engagement anticipated between the enterprise and the third party. Examples of potential transaction types include, a new engagement (for example, the first engagement between the enterprise and a third party), an add-on to an existing engagement (for example, an engagement anticipating that a third party previously engaged in a transaction with the enterprise would add a new product or service offered by the enterprise to the existing engagement), a renewal of an existing engagement, and so on.

The potential transaction object includes various attribute, for example, information identifying the third party, information identifying an item offered by the first enterprise that is a subject of the potential transaction, for example, a product or service offered by the first enterprise, an amount representing a value of the potential transaction, a date of creation of the potential transaction object or the date of initiation of the interaction between the first enterprise and the third party in connection with the potential transaction, an identifier of the user creating the potential transaction object, an identifier of the potential transaction object, an expected closing date for the potential transaction, and so on.

A potential transaction object is associated with a state that represents a stage of the potential transaction. A potential transaction object is associated with a current state that may change based on user interactions associated with the object. For example, a newly created potential transaction object is initialized to a “initial” state. If the third party decides to purchase the product or service offered by the first enterprise, the state of the potential transaction object is updated to a “closed won” state. Similarly if the third party confirms that the third party would not purchase the product or service offered by the first enterprise, the state of the potential transaction object is updated to a “closed lost” state or “omitted” state. A potential transaction object is also associated with a category such that each category maps to one or more stages that each potential transaction object can have. In an embodiment, the various stages and categories are defined by each enterprise based on the process used by the enterprise.

In an embodiment, the online system 100 receives the names of various stages from a user, for example, an administrator associated with an enterprise. Examples of stages associated with a potential transaction include “pipeline”, “closed”, “omitted”, “committed”, and so on. For example, a potential transaction object that is newly created is initialized to a “pipeline” stage, a potential transaction object is moved to a “best case” stage responsive to some promising interactions with the third party, the potential transaction object is in a “commit” stage if the potential transaction is undergoing negotiations of contract details, the potential transaction object is in a “closed won” stage if an actual transaction is executed responsive to a sale, the potential transaction object is in an “omitted” stage (or a “closed lost” stage) if the potential transaction fails and the sales opportunity is lost. The online system associates each stage of the potential transaction with a state of the potential transaction object. The online system 100 receives the specification of each stage describing the user interactions associated with a potential transaction object that cause the potential transaction object to have a particular stage and the user interactions that cause the potential transaction object to change from one stage to another stage. In an embodiment, potential objects of different type have different pipelines of stages.

The object historical data store 160 stores historical information associated with various objects. The historical information is stored as records, each record storing an object identifier for identifying the object associated with the activity, for example, an identifier for a potential transaction object. In an embodiment, the object manager 140 is configured to detect changes in attributes belonging to a set of attributes associated with objects. If the object manager 140 detects a change in value in any attribute from the set of attributes, the object manager stores a record describing the attributes of the object in the object historical data store 160. For example, for a potential transaction object, the object manager 140 stores a record in the object historical data store 160 if there is a change in value of any attribute including the state of the potential transaction object, an amount of the object, a predicted likelihood of success of the potential transaction, and so on. In an embodiment, the online system 100 uses the object identifier to associate various attributes describing the object with the record of the object historical data store 160.

Accordingly, the object historical data store 160 stores activities associated with an object comprising, creation of the object, any state changes associated with the object, any user interactions associated with the object, any change in an amount associated with a potential transaction object, a change in the probability of a potential transaction object reaching a “closed won” state or a “closed lost” (if the change in the probability is more than a threshold value), a change in a predicted state that a potential transaction object is expected to close, and so on.

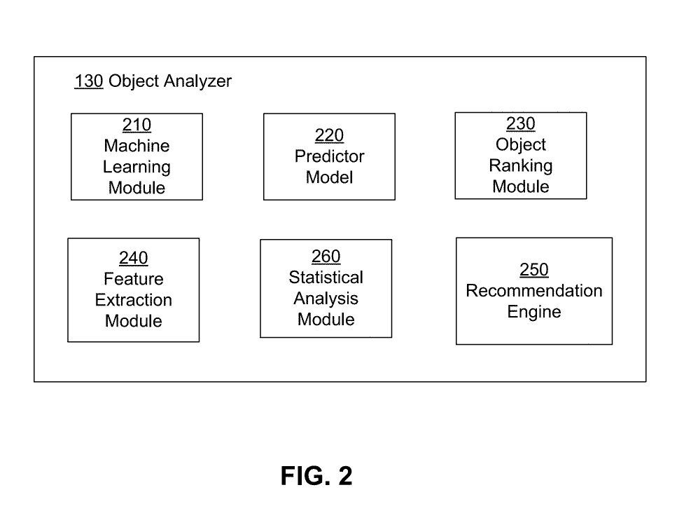

The object analyzer 130 uses the records stored in the object historical data store 160 as training data set for a machine learning model used for predicting information about the object, for example, for determining a probability of the object reaching a “closed won” state. The object state analyzer predicts a close data for a potential transaction object. The close date corresponds to a date that the potential transaction object is expected to reach a closed state, for example, a “closed won” state. Accordingly, the close date represents the date when an actual transaction corresponding to the potential transaction is executed, for example, responsive to a sale performed by the enterprise to a third party. The object analyzer 130 is described in detail in connection with FIG. 2.

The object manager 140 manages the stages of various potential transaction objects. The object manager 140 may receive input via the client application 115 indicating that the potential transaction has reached a particular stage. The object manager 140 modifies the state of the potential transaction object based on the received input. In an embodiment, the object manager 140 monitors user interactions performed by the user associated with the potential transaction object and modifies the state based on the monitored interactions.

In some embodiments, an online system 100 is a multi-tenant system. The online system 100 stores metadata describing the tenants in tenant metadata store 150. Each tenant may be an enterprise as described herein. As an example, one tenant might be a company that employs a sales force where each salesperson uses a client device 110 to manage their sales process. Thus, a user might maintain contact data, leads data, customer follow-up data, performance data, goals and progress data, etc., all applicable to that user's personal sales process.

In one embodiment, online system 100 implements a web-based customer relationship management (CRM) system. For example, in one embodiment, the online system 100 includes application servers configured to implement and execute CRM software applications as well as provide related data, code, forms, webpages and other information to and from client devices 110 and to store to, and retrieve from, a database system related data, objects, and webpage content.

With a multi-tenant system, data for multiple tenants may be stored in the same physical database, however, tenant data typically is arranged so that data of one tenant is kept logically separate from that of other tenants so that one tenant does not have access to another tenant's data, unless such data is expressly shared. The tenant metadata store 150 stores information that allows identification of data for different tenants, for example, using identifiers that uniquely identify each tenant. The tenant metadata store 150 stores various stages of potential transaction objects defined by an enterprise.

In certain embodiments, the online system 100 implements applications other than, or in addition to, a CRM application. For example, the online system 100 may provide tenant access to multiple hosted (standard and custom) applications, including a CRM application. According to one embodiment, the online system 100 is configured to provide webpages, forms, applications, data and media content to client devices 110 to support the access by client devices 110 as tenants of online system 100. As such, online system 100 provides security mechanisms to keep each tenant's data separate unless the data is shared.

A multi-tenant system may implement security protocols that keep data, applications, and application use separate for different tenants. In addition to user-specific data and tenant-specific data, the online system 100 may maintain system level data usable by multiple tenants or other data. Such system level data may include industry reports, news, postings, and the like that are sharable among tenants.

It is transparent to customers that their data may be stored in a table that is shared with data of other customers. A database table may store rows for a plurality of customers. Accordingly, in a multi-tenant system various elements of hardware and software of the system may be shared by one or more customers. For example, the online system 100 may execute an application server that simultaneously processes requests for a number of customers.

The online system 100 and client devices 110 shown in FIG. 1 can be executed using computing devices. A computing device can be a conventional computer system executing, for example, a Microsoft Windows™-compatible operating system (OS), Apple™ OS X, and/or a Linux distribution. A computing device can also be a client device having computer functionality, such as a personal digital assistant (PDA), mobile telephone, video game system, etc. The online system 100 stores the software modules storing instructions for embodiments, for example object analyzer 130.

The interactions between the client devices 110 and the online system 100 are typically performed via a network 170, for example, via the Internet. In one embodiment, the network uses standard communications technologies and/or protocols. In another embodiment, the entities can use custom and/or dedicated data communications technologies instead of, or in addition to, the ones described above. The techniques disclosed herein can be used with any type of communication technology, so long as the communication technology supports receiving by the online system 100 of web requests from a sender, for example, a client device 110 and transmitting of results obtained by processing the web request to the sender.

### System Architecture

FIG. 2 shows the system architecture of an object analyzer 130 for analyzing potential transaction objects, in accordance with an embodiment. The object analyzer 130 comprises a machine learning model 220, a feature extraction module 240, an object ranking module 230, a recommendation engine 250, a predictor model 220, and a statistical analysis module 260. Other embodiments may include more or fewer modules. Functionality indicated herein as being performed by a particular module may be performed by other modules.

The machine learning module 210 trains the predictor models 220 by extracting features describing potential transaction objects that were previously processed and creating a feature vector. The machine learning module 210 stores the predictor models 220. In an embodiment, the machine learning module 210 uses dimensionality reduction (e.g., via linear discriminant analysis, principle component analysis, etc.) to reduce the amount of data in the feature vector to a smaller, more representative core set of features.

The training set for the predictor models includes positive and negative examples comprising potential transaction objects that resulted in actual transactions and those that failed to result in actual transactions. Machine learning algorithms used include support vector machines (SVMs), boosting for other algorithms (e.g., AdaBoost), neural net, logistic regression, naïve Bayes, memory-based learning, random forests, bagged trees, decision trees, boosted trees, boosted stumps, etc.

In an embodiment, the machine learning module 210 uses random forest classification based on predictions from a set of decision trees. Each decision tree splits the source set into subsets based on an attribute value test. This process is repeated in a recursive fashion. A decision tree represents a flow chart, where each internal node represents a test on an attribute. For example, if the value of an attribute is less than or equal to a threshold value, the control flow transfers to a first branch and if the value of the attribute is greater than the threshold value, the control flow transfers to a second branch. Each branch represents the outcome of a test. Each leaf node represents a class label, i.e., a result of a classification.

Each decision tree uses a subset of the total predictor variables to vote for the most likely class for each observation. The final random forest score is based on the fraction of models voting for each class. A model may perform a class prediction by comparing the random forest score with a threshold value. In some embodiments, the random forest output is calibrated to reflect the probability associated with each class.

In an embodiment, a different machine learning model is trained for each type of the potential transaction (e.g., new business, an add-on business, a renewal and so on). This is so because the stages of each potential transaction type may be defined differently by the enterprise. Furthermore, the patterns of changes and user interactions for different potential transaction types may be different. Accordingly, the weights of features for predicting success of potential transactions of different potential transaction types may be different. Accordingly, a different machine learning model is trained and stored for each type of the potential transaction.

The feature extraction module 240 extract features of potential transaction objects for use by machine learning module 210 or the predictor model 220. The feature extraction module 240 extract features of potential transaction objects for use in training models by the machine learning module 210. The feature extraction module 240 also extract features of potential transaction objects for predicting information describing potential transaction objects, for example, for predicting a likelihood of a potential transaction object resulting in a successful transaction. In an embodiment, the feature extraction module 240 represents a feature using a name and a value.

Examples of features extracted by the feature extraction module 240 include the following: a rate of user interactions associated with the potential transaction object within a past time interval; a rate of updates to the potential transaction object; total number of updates to the potential transaction object since the potential transaction object was created; the age of the potential transaction object, i.e., the number of days since the potential transaction object was created; the number of days since last update to the potential transaction object; number of category changes since creation of the potential transaction object; a current category of the potential transaction object; number of days since the potential transaction object entered the current category; number of changes to the category since the potential transaction object was created; number of times the potential transaction object was in each category previously; total number of days spent in each category; the amount associated with the potential transaction object; the total number of updates made to the amount in a given time interval or since the potential transaction object was created.

In an embodiment, the predictor model 220 predicts the likelihood of success of a potential transaction object as a weighted aggregate value based on various features associated with the potential transaction object. The predictor model 220 determines that the likelihood of success of a potential transaction object is higher for a potential transaction object having a high rate of user interactions associated with the potential transaction object within a past time interval. The predictor model 220 determines that the likelihood of success of a potential transaction object is higher for a potential transaction object having a high rate of updates to the potential transaction object. The predictor model 220 determines that the likelihood of success of a potential transaction object is higher for a potential transaction object having a high total number of updates to the potential transaction object since the potential transaction object was created; The predictor model 220 determines that the likelihood of success of a potential transaction object is inversely proportionate with the age of the potential transaction object if the age of the potential transaction object exceeds a threshold value. The predictor model 220 determines that the likelihood of success of a potential transaction object is inversely proportionate to the number of days since last update to the potential transaction object. The predictor model 220 determines that the likelihood of success of a potential transaction object is higher for a potential transaction object having a high number of category changes since creation of the potential transaction object. The predictor model 220 determines that the likelihood of success of a potential transaction object is inversely proportionate to a number of days since the potential transaction object entered the current category. The predictor model 220 determines that the likelihood of success of a potential transaction object is directly proportionate to a number of changes to the category since the potential transaction object was created. The predictor model 220 determines that the likelihood of success of a potential transaction object is directly proportionate to the total number of updates made to the amount in a given time interval or since the potential transaction object was created.

The recommendation engine 250 recommends certain potential transactions to the user via the client application 115. The recommended potential transactions represent potential transactions for which the users are advised to perform certain actions associated with the potential transaction. The action associated with a potential transaction may depend on the current stage of the potential transaction. For example, an associated with a potential transaction may require a user of the enterprise to contact a corresponding user of the third party associated with the potential transaction. As another example, an action associated with a potential transaction may represent adjustment of an amount associated with the potential transaction. In an embodiment, the recommendation engine 250 identifies potential transaction that are likely to have the highest impact on the revenue of the enterprise at the end of a given time interval, for example, at the end of the month.

The object ranking module 230 ranks the recommended potential transaction objects for presenting to the user. In an embodiment, object ranking module 230 ranks the recommended potential transaction objects in order of their impact on the revenue of the enterprise at the end of a given time interval. In an embodiment, the object ranking module 230 ranks the recommended potential transactions based on a weighted aggregate value that is proportionate to a predicted likelihood that a potential transaction would result in a successful transaction and an amount associated with the potential transaction.

The statistical analysis module 260 performs statistical analysis of potential transaction objects to present various types of statistical information describing the potential transaction object. In an embodiment, the statistical analysis module 260 determines and presents estimates of revenue at the end of a time interval, for example, expected revenues at the end of a month.

### Overall Process

The processes associated with object analysis performed by online system 100 are described herein. The steps described herein for each process can be performed in an order different from those described herein. Furthermore, the steps may be performed by different modules than those described herein.

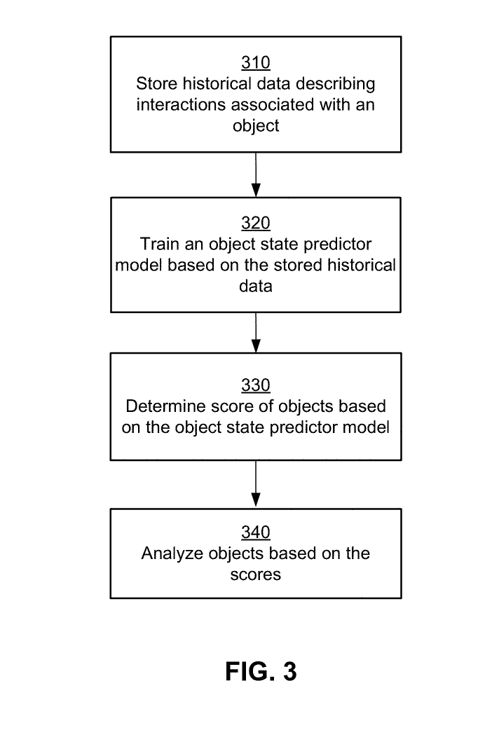

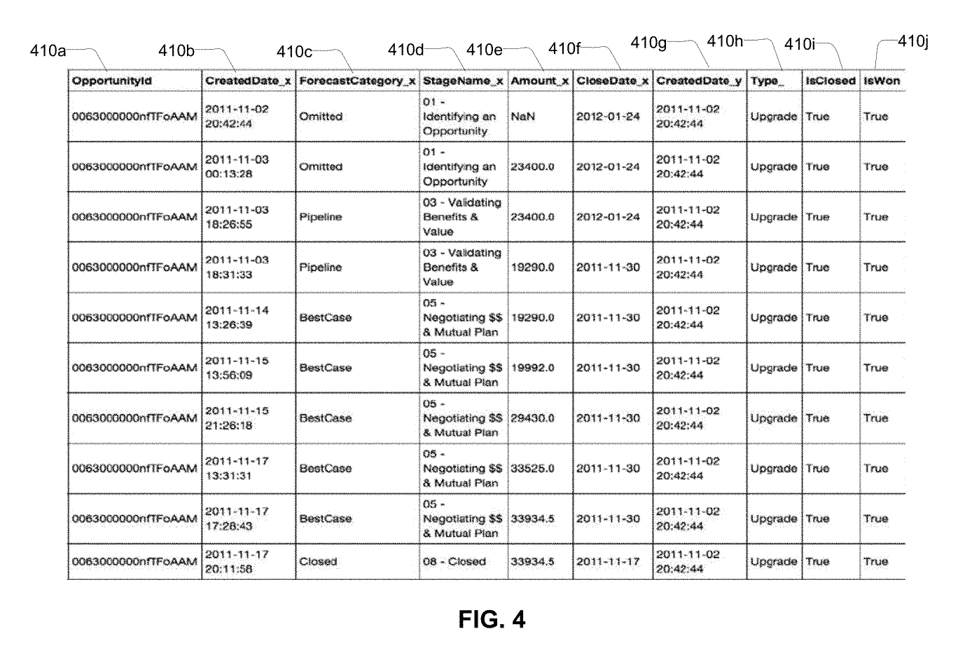

FIG. 3 shows the process of analyzing potential transaction objects, in accordance with an embodiment. The object historical data store 160 receives and stores 310 historical data describing activities associated with potential transaction objects. An example of historical data stored in object historical data store 160 is illustrated in FIG. 4.

The machine learning module 210 of the object analyzer 130 uses the records stored in the object historical data store 160 as training data set for training 320 a machine learning model used for predicting information about the object, for example, the predictor model 220. In an embodiment, the predictor model 220 determines a score indicating a probability of a potential transaction object reaching a “closed won” state.

The predictor model 220 receives various potential transaction objects and determines 330 a score value representing probability of each potential transaction object reaching a “closed won” state. The statistical analysis module 260 performs various types of analysis of the scores of the potential transaction objects for presentation to the user. For example, the statistical analysis module 260 predicts a month end revenue based on a particular selection of potential transaction objects.

The recommendation engine 250 recommends a set of potential transaction objects that maximizes the month end revenue. Accordingly, if the users associated with the recommended set of potential transaction objects performed actions associated with the recommended set of potential transaction objects, the states of these potential transaction objects are expected to change such that the predicted revenue numbers are realized at the end of a month.

FIG. 4 shows an example of historical data associated with a potential transaction object stored in the online system, in accordance with an embodiment. A record stored in the object historical data store 160 includes attributes describing an activity associated with the record. The attributes comprise, an identifier 410a for the potential transaction or opportunity corresponding to the activity represented by the record, the creation date 410b of the record indicating the date of the activity, a category 410c for the potential transaction at the time of creation of the record, the state 410d of the potential transaction object representing the current stage of the potential transaction, an amount 410e associated with the potential transaction (e.g., an amount representing a value of a product or service that is a subject of the potential transaction), an expected close date 410f representing a date when the potential transaction is expected to close, the creation date 410g of the potential transaction object identified by the identifier 410a, a type 410h of the potential transaction (for example, a type describing the engagement associated with the potential transaction, such as, a purchase, an upgrade, an upsell, and so on), a flag 410i indicating whether the potential transaction is closed, a flag 410j indicating whether the transaction is won or lost if the transaction is closed. Other embodiments may include more or fewer attributes in each record.

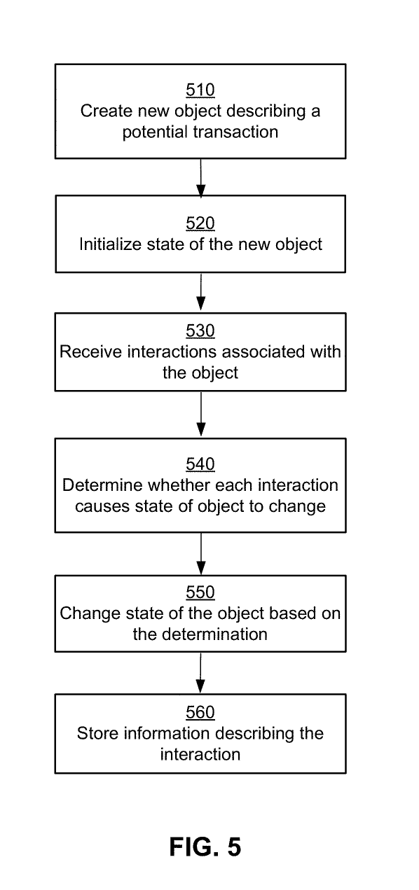

FIG. 5 shows the process of modifying the state of a potential transaction object, in accordance with an embodiment. The object manager 140 creates 510 a potential transaction object describing a potential transaction of an enterprise associated with the online system, for example, an enterprise representing a tenant of a multi-tenant system. In an embodiment, the object manager 140 creates 510 the new object in response to a request from a user associated with an online system, for example, a user responsible for performing user interactions associated with the potential transaction.

The object manager 140 initializes 520 the state of the potential transaction object created. The online system 100 may determine and store default value for the initial state of a potential transaction. For example, the online system may receive from a user of the online system, a default value of “initialized” as the initial state of the potential transaction object.

The online system 100 receives 530 information describing user interactions associated with the online system. In an embodiment, the user interaction manager 125 receives from the client application 115, an interaction associated with the potential transaction object and stores information describing the interaction in the object historical data store 160. For example, the client application 115 may allow a user of the online system 100 to interact with a user of a third party system 120 associated with the potential transaction via email or another online communication.

The object manager 140 determines 540 whether the interaction caused a change in state of the potential transaction object. The object manager 140 changes 550 the state of the potential transaction object based on the determination 540. For example, if the object manager 140 determines that no user interactions associated with the potential transactions were performed for more than a threshold amount of time, the object manager 140 changes the state of the potential transaction object to an “inactive” state. Similarly, if the object state manager 140 determines that an interaction associated with the potential transaction object having an “inactive” state was performed, the object manager 140 modifies the state of the potential transaction object to an “active” state. The object manager 140 stores information describing the interaction as a record in the object historical data store 160.

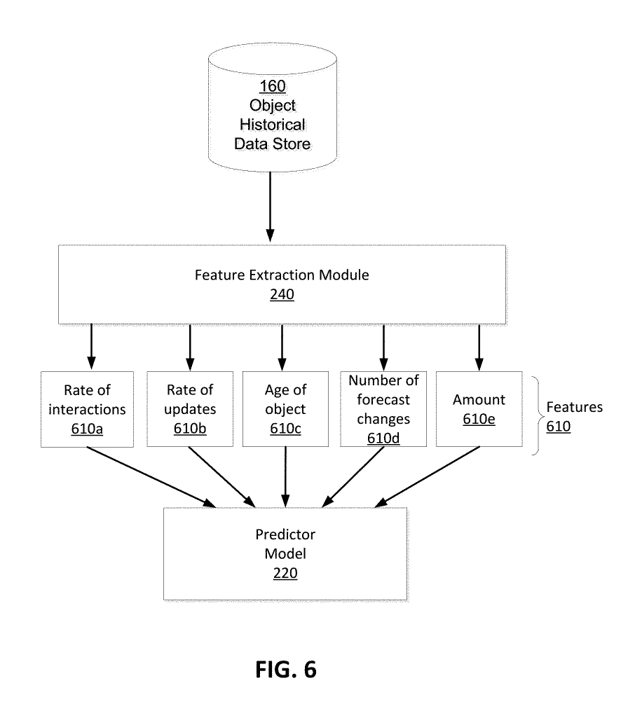

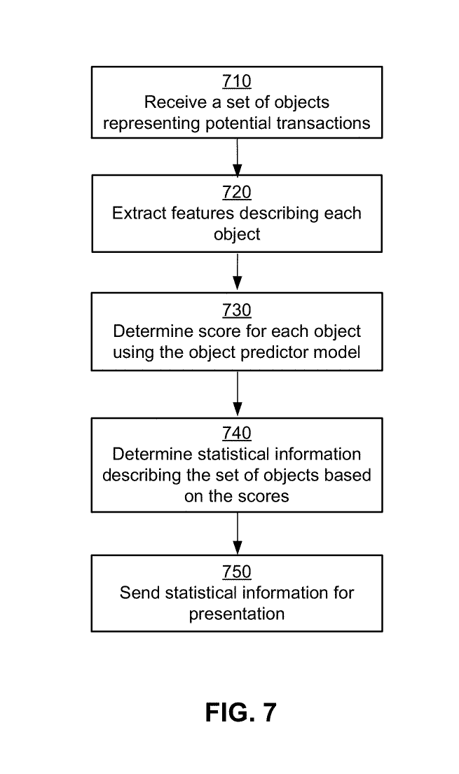

FIG. 6 shows the process of training a machine learning model for predicting success of a potential transaction, in accordance with an embodiment. As shown in FIG. 6, the feature extraction module 240 retrieves records representing historical data describing various activities associated with potential transaction objects from the object historical data store 160. The feature extraction module 240 extracts various features from the records retrieved from the object historical data store 160. Examples of features 610 illustrated in FIG. 7 include a feature 610a representing a rate of user interactions associated with a potential transaction object, a feature 610b representing a rate of updates to a potential transaction object, a feature 610c representing an age of a potential transaction object, a feature 610d representing a number of category changes to a potential transaction object, a feature 610e representing an amount associated with a potential transaction object, and so on. The machine learning module 210 uses the extracted features to train the predictor model 220.

FIG. 7 shows the process of analyzing potential transaction objects using machine learning models, in accordance with an embodiment. The predictor model 220 receives 710 a set of potential transaction objects for performing analysis. The set of potential transaction objects may represent all potential transaction objects associated with an enterprise. The set of potential transaction objects may represent all potential transaction objects of a particular transaction type associated with an enterprise. Alternatively, the set of potential transaction objects may be determined in any other way.

The feature extraction module 240 extracts 720 features of each of the potential transaction objects. The predictor model 220 determines 730 a score for each potential transaction object of the set. In an embodiment, the score represents a likelihood that the potential transaction object would result in a successful transaction for the enterprise associated with the potential transaction object. The statistical analysis module 260 determines 740 statistical information describing the set of potential transaction objects. For example, the statistical information may represent an estimate of total revenue at the end of a time period, for example, a month. The object analyzer 130 presents the statistical information to users via the client application 115.

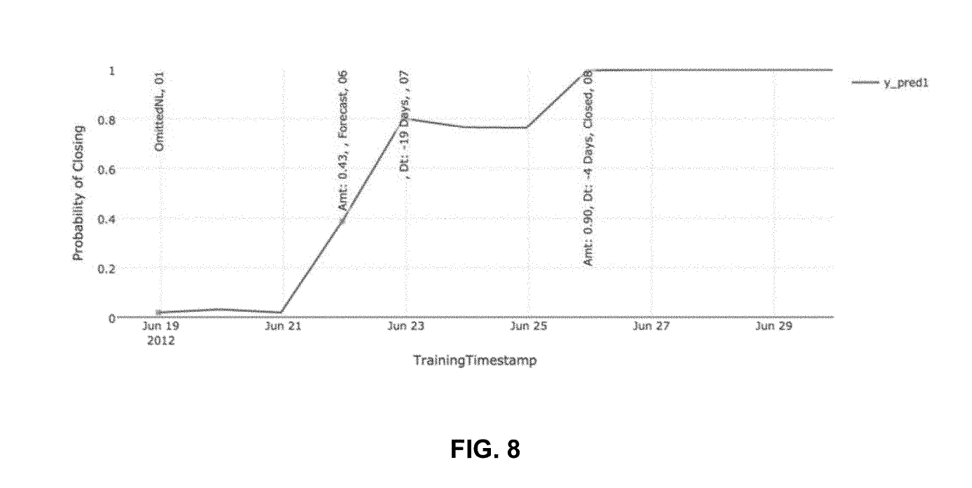

FIG. 8 illustrates how the predicted score for a potential transaction varies with time as a result of user interactions associated with the potential transaction, in accordance with an embodiment. The score represents the likelihood of success of a potential transaction represented by a probability of the potential transaction resulting in a “closed won” state. The chart illustrated in FIG. 8 shows the variation of score along the y-axis with respect to time shown along the x-axis. In an embodiment, the predicted score for the potential transaction stays constant for a time period until certain event occurs that causes the score value to change, for example, increase.

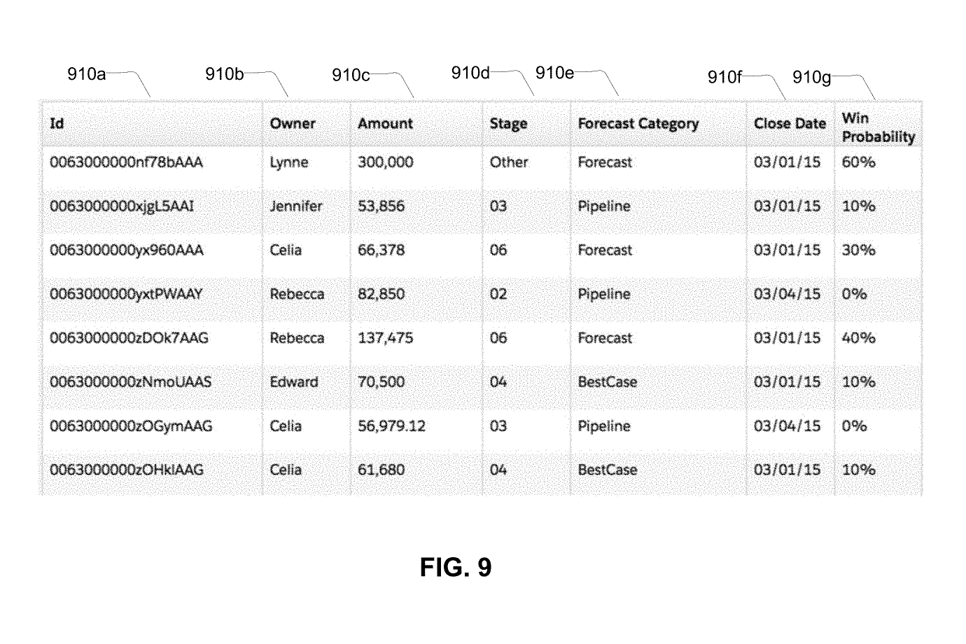

FIG. 9 illustrates a ranked list of potential transactions recommended by the online system, in accordance with an embodiment. The object ranking module 230 ranks the various potential transaction objects based on their significance. In an embodiment, the object ranking module 230 ranks the various potential transaction objects based on a weighted aggregate of the likelihood of the potential transaction closing successfully and an amount of the potential transaction. The object analyzer 130 sends the ranked list of potential transaction objects via the user interaction manager 125 to the client application 115 for presentation via a user interface. The user interface shows various attributes of the potential transaction objects including an identifier 910a of the potential transaction object, an owner 910b of the potential transaction object, an amount of the potential transaction associated with the potential transaction object, a stage of the potential transaction associated with the potential transaction object, a category, a close date, and a probability of success of the potential transaction object.

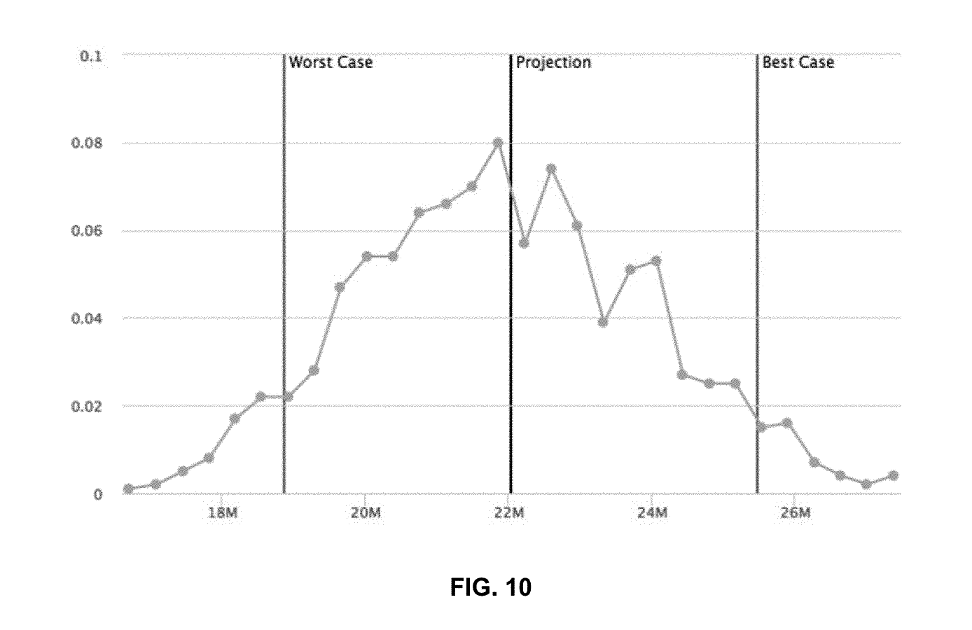

FIG. 10 illustrates an example of statistical analysis for predicting an aggregate amount expected from potential transactions at the end of a time period, in accordance with an embodiment. The statistical analysis shows an aggregate value of an estimated revenue at the end of a time period, for example, at the end of the month. In the chart shown in FIG. 10, a worst case estimate, a best case estimate, and a projection representing the most likely scenario. The various scenarios represent the estimate of the revenue from potential transactions exceeding a threshold likelihood of success.

### Alternative Embodiments

In an embodiment, the online system is a multi-tenant system and the feature object analyzer 130 determines a set of feature weights that optimizes the aggregate accessed results ranks for each tenant separately. Accordingly, a first set of feature weights is determined that predicts potential transaction object state information for a first tenant, a second set of feature weights is determined that potential transaction object state information for a second tenant, and so on. For example, the first set of feature weights may be for a tenant representing a first customer of the multi-tenant system, and the second set of feature weights may be for tenant representing a second customer of the multi-tenant system.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the Figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer implemented method for determining feature weights for ranking search results, the method comprising:
storing, by a system, data describing a plurality of potential transaction objects, each potential transaction object representing a potential transaction associated with an enterprise;
storing historical data describing user actions associated with each of the plurality of potential transaction objects;
storing a predictor model based on the stored historical data, the predictor model configured to determine a score for a potential transaction object, the score indicating a likelihood of success of a transaction based on the potential transaction object;
receiving a set of input potential transaction objects, each input potential transaction object representing a potential transaction associated with the enterprise;
for each of the set of input potential transaction objects:
extracting a set of features based on data associated with the potential transaction object, the set of features comprising features describing user interactions associated with the potential transaction object; and
determining, by the predictor model, a score for the potential transaction object, the score indicating a likelihood of success of a transaction based on the potential transaction object within a given time interval;
ranking the set of potential transaction objects based on the scores of the potential transaction objects; and
sending information describing the ranked set of potential transaction objects to a client device.

2. The method of claim 1, wherein each object is associated with an amount associated with a potential transaction, the method further comprising:
determining aggregate information based on the set of objects, the aggregate information describing an aggregate amount at the end of the time interval; and
wherein sending information describing the ranked set of objects to a client device comprises sending the aggregate information.

3. The method of claim 2, wherein the amount represents a total amount associated with a subset of objects, each object in the subset having a score within a predetermined range.

4. The method of claim 1, wherein the set of features comprises a feature indicating a rate of interactions associated with a potential transaction associated with the object, the interactions performed within a predetermined time interval.

5. The method of claim 1, wherein the set of features comprises a feature indicating a rate of updates to the object performed within a predetermined time interval.

6. The method of claim 1, wherein the set of features comprises a feature indicating a total number of updates to the object performed since the object was created.

7. The method of claim 1, wherein the set of features comprises a feature indicating a time since the last update was performed on the object.

8. The method of claim 1, wherein the set of features comprises a feature indicating a category, the category mapping to one or more stages of the potential transaction object.

9. The method of claim 8, wherein the set of features comprises a feature indicating a number of times the category of the object changed in a predetermined time interval.

10. The method of claim 8, wherein the set of features comprises a feature indicating a number of days since the object was in the category.

11. The method of claim 1, wherein the set of features comprises a feature indicating a number of days spent by the object in each category.

12. The method of claim 1, further comprising:
selecting recommendations of objects based on the ranking, the recommendations corresponding to objects with high scores; and
wherein sending information describing the ranked set of objects to a client device comprises sending the recommendations of objects.

13. The method of claim 1, wherein the system is a multi-tenant system storing data for a plurality of tenants, each tenant representing an enterprise.

14. The method of claim 13, wherein the predictor model is for a particular tenant of the multi-tenant system, the method further comprising:
selecting training data for training the predictor model based on historical data of the particular tenant.

15. The method of claim 14, wherein the predictor model is a first predictor model and the particular tenant is a first tenant, the method further comprising:
training a second predictor model based on stored historical data of a second tenant.

16. A computer readable non-transitory storage medium storing instructions for:
storing, by a system, data describing a plurality of potential transaction objects, each potential transaction object representing a potential transaction associated with an enterprise;
storing historical data describing user actions associated with each of the plurality of potential transaction objects;
storing a predictor model based on the stored historical data, the predictor model configured to determine a score for a potential transaction object, the score indicating a likelihood of success of a transaction based on the potential transaction object;
receiving a set of input potential transaction objects, each input potential transaction object representing a potential transaction associated with the enterprise;
for each of the set of input potential transaction objects:
extracting a set of features based on data associated with the potential transaction object, the set of features comprising features describing user interactions associated with the potential transaction object; and
determining, by the predictor model, a score for the potential transaction object, the score indicating a likelihood of success of a transaction based on the potential transaction object within a given time interval;
ranking the set of potential transaction objects based on the scores of the potential transaction objects; and
sending information describing the ranked set of potential transaction objects to a client device.

17. The computer readable non-transitory storage medium of claim 16, wherein each object is associated with an amount associated with a potential transaction, further storing instructions for:
determining aggregate information based on the set of objects, the aggregate information describing an aggregate amount at the end of the time interval; and
wherein sending information describing the ranked set of objects to a client device comprises sending the aggregate information.

18. The computer readable non-transitory storage medium of claim 16, further storing instructions for:
selecting recommendations of objects based on the ranking, the recommendations corresponding to objects with high scores; and
wherein sending information describing the ranked set of objects to a client device comprises sending the recommendations of objects.

19. A computer-implemented system comprising:
a computer processor; and
a computer readable non-transitory storage medium storing instructions thereon, the instructions when executed by a processor cause the processor to perform the steps of:
storing, by a system, data describing a plurality of potential transaction objects, each potential transaction object representing a potential transaction associated with an enterprise;
storing historical data describing user actions associated with each of the plurality of potential transaction objects;
storing a predictor model based on the stored historical data, the predictor model configured to determine a score for a potential transaction object, the score indicating a likelihood of success of a transaction based on the potential transaction object;
receiving a set of input potential transaction objects, each input potential transaction object representing a potential transaction associated with the enterprise;
for each of the set of input potential transaction objects:
extracting a set of features based on data associated with the potential transaction object, the set of features comprising features describing user interactions associated with the potential transaction object; and
determining, by the predictor model, a score for the potential transaction object, the score indicating a likelihood of success of a transaction based on the potential transaction object within a given time interval;
ranking the set of potential transaction objects based on the scores of the potential transaction objects; and
sending information describing the ranked set of potential transaction objects to a client device.

20. The computer system of claim 19, wherein each object is associated with an amount associated with a potential transaction, wherein the computer readable non-transitory storage medium further stores instructions for:
determining aggregate information based on the set of objects, the aggregate information describing an aggregate amount at the end of the time interval; and
wherein sending information describing the ranked set of objects to a client device comprises sending the aggregate information.
